(19) United States
(12) Patent Application Publication
(10) Pub. No.: US 2022/0259841 A1
(43) Pub. Date: Aug. 18, 2022

(54) THERMOSTATICALLY WRAPPED PRESS-TYPE PHOTOSENSITIVE SPRAY SHOWER

(71) Applicant: GUANGZHOU SEAGULL KITCHEN AND BATH PRODUCTS CO., LTD., Guangdong (CN)

(72) Inventors: Jacky PENG, Guangzhou (CN); Mingzi ZHANG, Jiangmen (CN); Tao LUO, Xianning (CN); Aizhao WEI, Kaifeng (CN)

(73) Assignee: GUANGZHOU SEAGULL KITCHEN AND BATH PRODUCTS CO., LTD., Guangdong (CN)

(21) Appl. No.: 17/428,288

(22) PCT Filed: Jan. 28, 2021
(86) PCT No.: PCT/CN2021/074262

§ 371 Date: Aug. 4, 2021

(30) Foreign Application Priority Data
Aug. 28, 2020 (CN) 202010893036.2
Aug. 28, 2020 (CN) 202021853760.4

(51) Int. Cl. E03C 1/04; A47K 3/28

(52) U.S. Cl. CPC E03C 1/0409; B05B 1/185; A47K 3/282

(57) ABSTRACT

A thermostatically wrapped press-type photosensitive spray shower includes a fixing base; a handheld shower; a pair of side arms whose two opposite sides are provided with a plurality of spray nozzles at intervals. A water conduit system including a main conduit and two first branches. Two water conduit branches being provided between two ends of each of two first branches, one of the two water conduit branches is equipped with a manual pressing valve, the other one of the two water conduit branches is equipped with a solenoid valve, a touch switch of the solenoid valves is assembled on a pressing panel of manual pressing valve. The pair of side arms can spray comprehensively by cooperating with a handheld shower. A mechanical pressing and touch dual-mode switch of a water outlet mechanism is provided.

### TECHNICAL FIELD

The present invention relates to the field of bathroom devices, and in particular to a thermostatically wrapped press-type photosensitive spray shower.

### BACKGROUND

With the development of society and the progress of the era, people have higher and higher requirements for life. Shower is favored by the public because of its advantages of convenience, easy operation and space-saving. However, the existing shower only includes a handheld shower, and water from the handheld shower can only be sprayed to a local part of a human body. It is difficult to spray the human body comprehensively by the handheld shower, which affects the experience feeling and comfort sense of users when taking a shower. In addition, a water outlet mechanism of the existing shower mostly adopts a pressing switch or touch-sensitive switch. However, the pressing switch alone has the problem that a pressing force is too low or too high during pressing, which causes poor user experience feeling. The touch-sensitive switch alone has the problem that the water outlet mechanism cannot work when the battery power supply is insufficient or the circuit fails.

### SUMMARY

An object of the present invention is to solve at least above problems, and to provide, at least, the advantages that will be described later.

Another object of the present invention is to provide a thermostatically wrapped press-type photosensitive spray shower, which is provided with a pair of side arms capable of spraying, which can be used to spray a human body comprehensively by cooperating with a handheld shower, and improves the experience feeling and comfort sense of users when taking a shower. In addition, the spray shower is also provided with a mechanical pressing and touch dual-mode switch of a water outlet mechanism, which can improve user experience feeling and can still ensure the normal operation of the water outlet mechanism by mechanically pressing the switch when the touch mode fails, thereby ensuring the normal use of the spray shower.

In view of objects mentioned above and other advantages, the present invention provides a thermostatically wrapped press-type photosensitive spray shower, being characterized in that, the spray shower comprises:

a fixing base, which is arranged on a wall;

a handheld shower, which is hung on the wall;

a pair of side arms, which are respectively arranged on both sides of the fixing base, wherein, one end of each of the pair of side arms is connected with the fixing base, an end face of the other end is sealed; the pair of side arms are hollow structures, and two opposite sides of the pair of side arms are provided with a plurality of spray nozzles at intervals;

a water conduit system, which is integrated in the fixing base, and comprises a main conduit and two first branches; wherein, one end of the main conduit is in communication with a water supply pipe, the other end of the main conduit is in communication with one end of each of the two first branches, the other end of one of the two first branches is in communication with the handheld shower, the other end of the other of the two first branches is in communication with inside of the pair of side arms, two water conduit branches are provided between two ends of each of the two first branches, one of the two water conduit branches is equipped with a manual pressing valve for turning on and off the one of the two water conduit branches, the other of the two water conduit branches is equipped with a solenoid valve for turning on and off the other of the two water conduit branches, the solenoid valve is connected to a touch switch, and the touch switch is assembled on a pressing panel of the manual pressing valve corresponding to the touch switch.

Preferably, in the thermostatically wrapped press-type photosensitive spray shower, the touch switch is a photosensitive touch switch and comprises a touch screen whose central part is provided with a light transmission area, a photosensitive sensor, and a controller connected with the photosensitive sensor; wherein, a central part of the pressing panel is provided with an opening, the touch screen is assembled in the opening corresponding to the touch screen, the photosensitive sensor is assembled on an inner side of the pressing panel, the light transmission area and the photosensitive sensor are arranged corresponding to a direction along a pressing path of the pressing panel, and the controller is connected with the solenoid valve corresponding to the controller.

Preferably, in the thermostatically wrapped press-type photosensitive spray shower, an outer surface of the touch screen is recessed inward.

Preferably, in the thermostatically wrapped press-type photosensitive spray shower, the water conduit system further comprises a second branch for anti-freezing and draining, wherein, one end of the second branch is in communication with the other end of the main conduit, the other end of the second branch is in communication with a drain-pipe, and the second branch is provided with a manual rotary valve for turning on and off the second branch.

Preferably, in the thermostatically wrapped press-type photosensitive spray shower, one end of the water supply pipe is in communication with one end of the main conduit, the other end of the water supply pipe is in communication with a hot water inlet and cold water inlet through a thermostatic cartridge, and the thermostatic cartridge is used for adjusting the amount of hot water and cold water discharged from the hot water inlet and the cold water inlet, mixing the hot water and cold water and transporting the hot water and cold water to the main conduit.

Preferably, in the thermostatically wrapped press-type photosensitive spray shower, one end of each of the pair of side arms is rotatably connected with the fixing base, and the other end of each of the pair of side arms is inclined and bent toward a side where the spray nozzles are located.

Preferably, in the thermostatically wrapped press-type photosensitive spray shower, a spray head is provided inside of each of the spray nozzles, a water guide block with a cylindrical structure whose axis extends along a spray path is correspondingly provided inside of an water outlet of the spray head, an outer wall of the water guide block is provided with a spiral groove extending along an axial direction of the water guide block, the spiral groove and an inner wall of the spray head form a spiral water outlet channel, a central part of the spiral water outlet channel is provided with a through hole with a cylindrical structure extending along an axis of the spiral water outlet channel, a central part of the through hole is provided with a stopper perpendicular to the axis of the water guide block, and a central part of the stopper is provided with a water outlet hole.

Preferably, in the thermostatically wrapped press-type photosensitive spray shower, the spray shower further comprises a seat unit which comprises a back plate fixed on the wall and a folding plate hinged to the back plate; wherein, the back plate is located below the fixing base, and the folding plate comprises a first plate body whose one end is hinged to an external surface of the back plate, and a second plate body whose one end is hinged to the other end of the first plate body;

when the folding plate is opened, the first plate body rotating to a horizontal state relative to the back plate, and the second plate body rotating to a vertical state and the bottom of the second plate body is in contact with the ground; when the folding plate is folded up, both the first plate body and the second plate body rotating to a vertical state relative to the back plate, the first plate body and the second plate body overlapping each other, and the first plate body being in close contact with the external surface of the back plate.

Preferably, in the thermostatically wrapped press-type photosensitive spray shower, two safety handrails are symmetrically provided on both sides of the back plate, and each of the two safety handrails is hinged with a side of the back plate.

Preferably, in the thermostatically wrapped press-type photosensitive spray shower, the external surface of the back plate is provided with a plurality of spherical protrusions at intervals.

The present invention comprises at least the following substantial improvements and beneficial effects:

1. The present invention is provided with a pair of side arms capable of spraying, which can be used to spray a human body comprehensively by cooperating with a handheld shower, and improves the experience feeling and comfort sense of users when taking a shower. In addition, the spray shower is also provided with a mechanical pressing and touch dual-mode switch of a water outlet mechanism, which can improve user experience feeling and can still ensure the normal operation of the water outlet mechanism by mechanically pressing the switch when the touch mode fails, thereby ensuring the normal use of the spray shower.

2. The touch sensitivity of the touch screen is set to be effective when touching the surface of the light transmission area, that is, the solenoid valve will be turned on or off when touching the light transmission area by hand. When a hand touches the touch screen, light in the photosensitive area is blocked, the photosensitive sensor receives a signal of the light change, then the signal is transmitted to the controller, and the controller controls turning on and off the solenoid valve, thereby realizing the control of turning on and off of the other water branch by the touch switch. The touch switch is assembled on the pressing panel, the pressing panel can be set on a side of the fixing base away from the wall, and the touch switch or the pressing switch can be turned on or off by touching or pressing the same position. The integrated design saves space and simplifies the pressing operation.

3. A triple helix water guide block is provided inside of a water outlet of the spray head, water flow in a triple helix water outlet channel can form a high-speed rotating jet channel. A stopper is provided at the central part of the cylindrical through hole, and a water outlet hole is provided in the central part of the stopper to form a central direct-jet hole which enables the water molecules to collide around to form a water mist effect and improve shower effect by cooperating with high-speed rotating water flows from three water outlet channels.

Other advantages, objects, and features of the present invention will be showed in part through following description, and in part will be understood by those skilled in the art from study and practice of the present invention.

### BRIEF DESCRIPTION OF THE DRAWINGS

FIG. 1 is a structural view of the thermostatically wrapped press-type photosensitive spray shower according to the present invention.

FIG. 2 is a structural view of the thermostatically wrapped press-type photosensitive spray shower when the pair of side arms are extended according to the present invention.

FIG. 3 is a structural view of the thermostatically wrapped press-type photosensitive spray shower when the pair of side arms are retracted according to the present invention.

FIG. 4 is a sectional view of the side arms according to the present invention.

FIG. 5 is a partial enlarged view of A in FIG. 4.

Reference signs: 1: a fixing base; 2: a handheld shower; 3: a pair of side arms; 31: a spray nozzle; 311: water guide block; 4: pressing panel; 5: a switch of a thermostatic cartridge; 61: a back plate; 611: a safety handrail; 62: a first plate body; 63: a second plate body.

### DETAILED DESCRIPTION

The present invention will now be described in further detail with reference to the accompanying drawings and embodiments in order to enable person skilled in the art to practice with reference to the specification.

It should be noted that terms such as “having”, “including” and “comprising” as used herein do not exclude presence or addition of one or more other elements or combinations thereof.

It should be noted that the experimental methods described in the following embodiments are all conventional methods unless otherwise specified, and the reagents and materials are commercially available unless otherwise specified.

It should be noted that in the description of the present invention, the terms indicating orientations or positional relationships such as “transverse”, “longitudinal”, “up”, “down”, “front”, “behind”, “left”, “right”, “vertical”, “horizontal”, “top”, “bottom”, “inner”, “outer” and the like are based on the orientation or positional relationships shown in the drawings for convenience of describing the present invention and simplifying description. It is not intended or implied that the device or element must have a particular orientation and be constructed and operated in a particular orientation, and therefore it should not be construed as limiting the present invention.

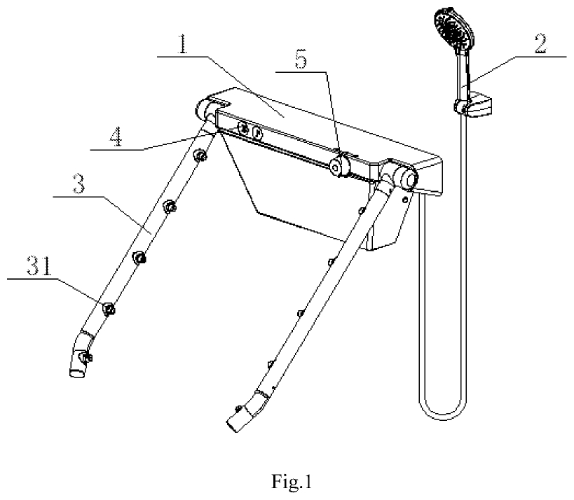

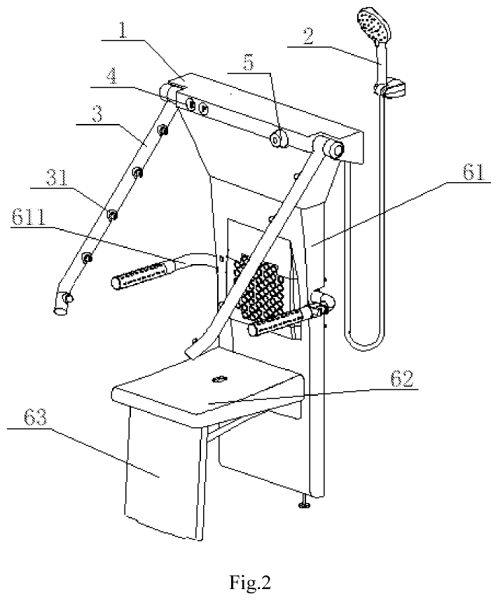

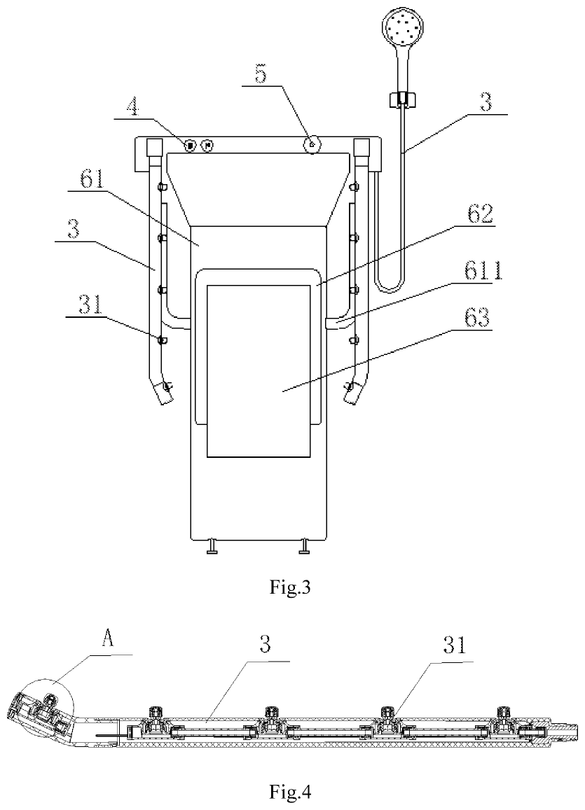

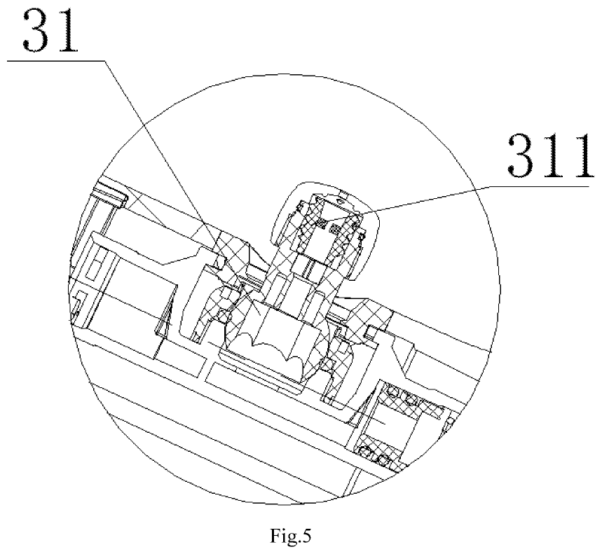

As shown in FIG. 1-FIG. 5, the present invention provides a thermostatically wrapped press-type photosensitive spray shower, including:

a fixing base 1, which is arranged on a wall;

a handheld shower 2, which is hung on the wall;

a pair of side arms 3, which are respectively arranged on both sides of the fixing base 1, wherein, one end of each of the pair of side arms 3 is connected with the fixing base 1, an end face of the other end is sealed, the pair of side arms 3 are hollow structures, and two opposite sides of the pair of side arms 3 are provided with a plurality of spray nozzles 31 at intervals;

a water conduit system, which is integrated in the fixing base 1, and includes a main conduit and two first branches; wherein, one end of the main conduit is in communication with a water supply pipe, the other end of the main conduit is in communication with one end of each of the two first branches, the other end of one of the two first branches is in communication with the handheld shower 2, the other end of the other of the two first branches is in communication with inside of the pair of side arms 3, two water conduit branches are provided between two ends of each of the two first branches, one of the two water conduit branches is equipped with a manual pressing valve for turning on and off the one of the two water conduit branches, the other of the two water conduit branches is equipped with a solenoid valve for turning on and off the other of the two water conduit branches, the solenoid valve is connected to a touch switch, and the touch switch is assembled on a pressing panel 4 of the manual pressing valve corresponding to the touch switch.

In the above technical solution, the present invention is provided with a pair of side arms 3 capable of spraying, which can be used to spray a human body comprehensively by cooperating with a handheld shower 2, and improves the experience feeling and comfort sense of users when taking a shower. In addition, the spray shower is also provided with a mechanical pressing and touch dual-mode switch of a water outlet mechanism, which can improve user experience feeling and can still ensure the normal operation of the water outlet mechanism by mechanically pressing the switch when the touch mode fails, thereby ensuring the normal use of the spray shower.

In the use of the thermostatically wrapped press-type photosensitive spray shower, the handheld shower 2 can be used to spray water from the top of the head, and the pair of side arms 3 can be used to spray water mist from both sides of a human body, so that the human body can be surrounded by hot water circumferentially, thereby providing a relaxed, warm and comfortable full-body shower for the user. In a practical application, a seat can be set in the shower position according to practical need, which can satisfy user's sitting shower and further improve the comfort sense of the spray shower. The present invention provides two first branches which are used for connecting the handheld shower 2 and the pair of side arms 3 with the main conduit, respectively, and the two first branches are turned on and off by the control of the manual pressing valve and the solenoid valve. When the battery power supply of the solenoid valve is sufficient and the circuit is normal, the solenoid valve can be turned on by touching the touch switch by hand, and the other of the two water conduit branches is in communication with water, so as to realize communication of the two first branches with water (shower state). The solenoid valve can be turned off by touching the touch switch again, and the other of the two water conduit branches is turned off (not in communication with water), so as to realize no communication of the two first branches with water (no shower state). When the battery power supply of the solenoid valve is insufficient or the circuit is abnormal, the manual pressing mode can be adopted, the manual pressing valve is turned on and off to realize turning on and off of one of the two water conduit branches, so as to realize communication and no communication of the two first branches with water. That is, the manual pressing valve is used as an emergency means to ensure the normal use of the spray shower when the solenoid valve fails due to power shortage or circuit failure.

In another technical solution, in the thermostatically wrapped press-type photosensitive spray shower, the touch switch is a photosensitive touch switch and includes a touch screen whose central part is provided with a light transmission area, a photosensitive sensor, and a controller connected with the photosensitive sensor, a central part of the pressing panel 4 is provided with an opening, the touch screen is assembled in the opening corresponding to the touch screen, the photosensitive sensor is assembled on an inner side of the pressing panel 4, the light transmission area and the photosensitive sensor are arranged corresponding to a direction along a pressing path of the pressing panel 4, and the controller is connected to the solenoid valve corresponding to the controller.

In the above technical solution, the touch sensitivity of the touch screen is set to be effective when touching the surface of the light transmission area, that is, the solenoid valve will be turned on or off when touching the light transmission area by hand. When a hand touches the touch screen, light in the photosensitive area is blocked, the photosensitive sensor receives a signal of the light change, then the signal is transmitted to the controller, and the controller controls turning on and off the solenoid valve, thereby realizing the control of turning on and off of the other water branch by the touch switch.

The touch switch is assembled on the pressing panel 4, the pressing panel 4 can be set on a side of the fixing base 1 away from the wall, and the touch switch or the pressing switch can be turned on or off by touching or pressing the same position. The integrated design saves space and simplifies the pressing operation.

In another technical solution, in the thermostatically wrapped press-type photosensitive spray shower, an outer surface of the touch screen is recessed inward. The inwardly recessed structural design can avoid false triggering caused by a false touch of the touch screen by a body or a cover (such as a false touch by an arm or other parts when taking a shower).

In another technical solution, in the thermostatically wrapped press-type photosensitive spray shower, the water conduit system further includes a second branch for anti-freezing and draining, wherein, one end of the second branch is in communication with the other end of the main conduit, the other end of the second branch is in communication with a drain-pipe, and the second branch is provided with a manual rotary valve for turning on and off the second branch. In the winter, when the temperature is low, the second branch can be turned on by turning the manual rotary valve to prevent the internal of the water conduit system from freezing, which will cause the spray shower to be unusable.

In another technical solution, in the thermostatically wrapped press-type photosensitive spray shower, one end of the water supply pipe is in communication with one end of the main conduit, the other end of the water supply pipe is in communication with a hot water inlet and cold water inlet through a thermostatic cartridge, and the thermostatic cartridge is used for adjusting the amount of hot water and cold water discharged from the hot water inlet and the cold water inlet, mixing the hot water and cold water and transporting the hot water and cold water to the main conduit. The thermostatic cartridge is used for adjusting water temperature and further improving the experience feeling and comfort sense of the shower. A switch 5 of the thermostatic cartridge is arranged on a side surface of the fixing seat 1 away from the wall.

In another technical solution, in the thermostatically wrapped press-type photosensitive spray shower, one end of each of the pair of side arms 3 is rotatably connected with the fixing base 1. The design of the rotating connection can realize the self-adjustment of the position of the pair of side arms 3, and can also rotate the pair of side arms 3 to a vertical state for storage when the pair of side arms 3 are not needed, which improves the flexibility of the spray shower.

In another technical solution, in the thermostatically wrapped press-type photosensitive spray shower, a spray head is provided inside of each of the spray nozzles 31, a water guide block 311 with a cylindrical structure whose axis extends along a spray path is correspondingly provided inside of an water outlet of the spray head, an outer wall of the water guide block 311 is provided with three spiral grooves extending along an axial direction of the water guide block, each of the three spiral groove and an inner wall of the spray head form a spiral water outlet channel, a central part of the spiral water outlet channel is provided with a through hole with a cylindrical structure extending along an axis of the spiral water outlet channel, a central part of the through hole is provided with a stopper perpendicular to the axis of the water guide block 311, and a central part of the stopper is provided with a water outlet hole. The water guide block 311 with a triple helix structure is provided inside of a water outlet of the spray head, water flow in the spiral water outlet channel with a triple helix structure can form a high-speed rotating jet channel. The stopper is provided at the central part of the through hole with a cylindrical structure, and the water outlet hole is provided in the central part of the stopper to form a central direct-jet hole which enables the water molecules to collide around to form a water mist effect and improve shower effect by cooperating with high-speed rotating water flows from three spiral water outlet channels.

In another technical solution, the thermostatically wrapped press-type photosensitive spray shower further includes a seat unit which includes a back plate 61 fixed on the wall and a folding plate hinged to the back plate 61; wherein, the back plate 61 is located below the fixing base 1, and the folding plate includes a first plate body 62 whose one end is hinged to an external surface of the back plate 61, and a second plate body 63 whose one end is hinged to the other end of the first plate body 62.

When the folding plate is opened, the first plate body 62 rotates to a horizontal state relative to the back plate 61, the second plate body 63 rotates to a vertical state, and the bottom of the second plate body 63 is in contact with the ground. When the folding plate is folded up, both the first plate body 62 and the second plate body 63 rotate to a vertical state relative to the back plate 61, the first plate body 62 and the second plate body 63 overlap each other, and the first plate body 62 is in close contact with the external surface of the back plate 61.

In the above technical solution, the seat unit is arranged below the fixing seat 1, and the seat unit is set to be foldable. When a sitting shower is required, the folding plate can be opened. The first plate body 62 and the second plate body 63 form a L-shaped structure, the first plate body 62 is used as a seat plate, and the second plate body 63 is used as a support plate for supporting the seat plate. The user can sit on the upper surface of the first plate body 62 and take a shower. In a practical application, a plurality of draining holes are provided on the first plate body 62 to facilitate the rapid discharge of the water on the first plate body 62. When a sitting shower is not required, the folding plate can be folded, the first plate body 62 and the second plate body 63 can be rotated to a vertical folding state, and the first plate body 62 and the second plate body 63 are housed on the external surface of the back plate 61, which do not affect a standing shower. The present invention has a simple structure, high use flexibility, and high practicability.

In another technical solution, in the thermostatically wrapped press-type photosensitive spray shower, two safety handrails 611 are symmetrically provided on both sides of the back plate 61, one end of each of the two safety handrails 611 is hinged with a side of the back plate 61, the other end of each of the two safety handrails 611 is inclined and bent toward a direction where the spray nozzles 31 are located. The two safety handrails 611 are arranged on both sides of the back plate 61 to provide a place for placing arms in the sitting shower, so as to avoid lifting arms for a long time and save physical strength and provide a safer, more reliable and comfortable shower mode for the elderly, children or other users have difficulty in moving. The other end of each of the pair of side arms 3 are inclined and bent towards a direction close to each other, which can better surround the human body circumferentially.

In another technical solution, in the thermostatically wrapped press-type photosensitive spray shower, the external surface of the back plate 61 is provided with a plurality of spherical protrusions at intervals. Each of the plurality of spherical protrusions is made of ASA material, which is equivalent to setting a plurality of massage balls on the back plate 61. When a user adopts sitting shower, his back can be attached to the massage balls, so that he can enjoy back massage while taking a sitting shower, and improve the comfort sense of shower.

The number of devices and processing scale described here are used to simplify the description of the present invention. The application, modification and changes of the present invention will be obvious to those skilled in the art.

Although the embodiments of the present invention have been disclosed above, they are not limited to the applications previously mentioned in the specification and embodiments, and can be applied in various fields suitable for the present invention. For those skilled in the art, additional modifications can be easily implemented, so without departing from the general concept defined by the claims and equivalent scope, the present invention is not limited to the specific details and the illustrations shown and described here.

1. A thermostatically wrapped press-type photosensitive spray shower, the spray shower comprising:
a fixing base, which is arranged on a wall;
a handheld shower, which is hung on the wall;
a pair of side arms, which are respectively arranged on both sides of the fixing base, wherein, one end of each of the pair of side arms is connected with the fixing base, an end face of the other end of each of the pair of side arms is sealed; the pair of side arms are hollow structures, and two opposite sides of the pair of side arms are provided with a plurality of spray nozzles at intervals; and
a water conduit system, which is integrated in the fixing base, and comprises a main conduit and two first branches; wherein, one end of the main conduit is in communication with a water supply pipe, the other end of the main conduit is in communication with one end of each of the two first branches, the other end of one of the two first branches is in communication with the handheld shower, the other end of the other one of the two first branches is in communication with inside of the pair of side arms, two water conduit branches are provided between two ends of each of the two first branches, one of the two water conduit branches is equipped with a manual pressing valve for turning on and off the one of the two water conduit branches, the other one of the two water conduit branches is equipped with a solenoid valve for turning on and off the other one of the two water conduit branches, the solenoid valve is connected to a touch switch, and the touch switch is assembled on a pressing panel of the manual pressing valve corresponding to the touch switch.

2. The thermostatically wrapped press-type photosensitive spray shower according to claim 1, wherein the touch switch is a photosensitive touch switch and comprises a touch screen whose central part is provided with a light transmission area, a photosensitive sensor, and a controller connected with the photosensitive sensor; wherein, a central part of the pressing panel is provided with an opening, the touch screen is assembled in the opening corresponding to the touch screen, the photosensitive sensor is assembled on an inner side of the pressing panel, the light transmission area and the photosensitive sensor are arranged corresponding to a direction along a pressing path of the pressing panel, and the controller is connected with the solenoid valve corresponding to the controller.

3. The thermostatically wrapped press-type photosensitive spray shower according to claim 2, wherein an outer surface of the touch screen is recessed inward.

4. The thermostatically wrapped press-type photosensitive spray shower according to claim 1, wherein the water conduit system further comprises a second branch for anti-freezing and draining, wherein, one end of the second branch is in communication with the other end of the main conduit, the other end of the second branch is in communication with a drain-pipe, and the second branch is provided with a manual rotary valve for turning on and off the second branch.

5. The thermostatically wrapped press-type photosensitive spray shower according to claim 1, wherein one end of the water supply pipe is in communication with one end of the main conduit, the other end of the water supply pipe is in communication with a hot water inlet and cold water inlet through a thermostatic cartridge, and the thermostatic cartridge is configured for adjusting an amount of hot water and cold water discharged from the hot water inlet and the cold water inlet, and mixing the hot water and cold water and transporting the hot water and cold water to the main conduit.

6. The thermostatically wrapped press-type photosensitive spray shower according to claim 1, wherein one end of each of the pair of side arms is rotatably connected with the fixing base, and the other end of each of the pair of side arms is inclined and bent toward a side where the spray nozzles are located.

7. The thermostatically wrapped press-type photosensitive spray shower according to claim 1, wherein a spray head is provided inside of each of the spray nozzles, a water guide block with a cylindrical structure whose axis extends along a spray path is correspondingly provided inside of an water outlet of the spray head, an outer wall of the water guide block is provided with a spiral groove extending along an axial direction of the water guide block, the spiral groove and an inner wall of the spray head form a spiral water outlet channel, a central part of the spiral water outlet channel is provided with a through hole with a cylindrical structure extending along an axis of the spiral water outlet channel, a central part of the through hole is provided with a stopper perpendicular to the axis of the water guide block, and a central part of the stopper is provided with a water outlet hole.

8. The thermostatically wrapped press-type photosensitive spray shower according to claim 1, further comprising a seat unit which comprises a back plate fixed on the wall and a folding plate hinged to the back plate; wherein, the back plate is located below the fixing base, and the folding plate comprises a first plate body whose one end is hinged to an external surface of the back plate, and a second plate body whose one end is hinged to the other end of the first plate body;
when the folding plate is opened, the first plate body rotates to a horizontal state relative to the back plate, and the second plate body rotating to a vertical state and a bottom of the second plate body is in contact with a ground; when the folding plate is folded up, both the first plate body and the second plate body rotates to the vertical state relative to the back plate, the first plate body and the second plate body overlap each other, and the first plate body is in close contact with the external surface of the back plate.

9. The thermostatically wrapped press-type photosensitive spray shower according to claim 8, wherein two safety handrails are symmetrically provided on both sides of the back plate, and each of the two safety handrails is hinged with a side of the back plate.

10. The thermostatically wrapped press-type photosensitive spray shower according to claim 9, wherein the external surface of the back plate is provided with a plurality of spherical protrusions at intervals.
